(19) United States
(12) Patent Application Publication
(10) Pub. No.: US 2006/0140123 A1
(43) Pub. Date: Jun. 29, 2006

(54) Methods and apparatus for distributing link-state information associated with a wireless mesh network

(75) Inventors: W. Steven Conner, Hillsboro, OR (US); Harkirat Singh, Portland, OR (US); Jing Z. Zhu, Hillsboro, OR (US)

Correspondence Address: INTEL CORPORATION, P.O. BOX 5326, SANTA CLARA, CA, 95056-5326, US

(73) Assignee: INTEL CORPORATION

(21) Appl. No.: 11/025,612

(22) Filed: Dec. 29, 2004

(51) Int. Cl. H04L 12/26

(52) U.S. Cl. 370/238

(57) ABSTRACT

Embodiments of methods and apparatus for distributing link-state information associated with a wireless mesh network are generally described herein. Other embodiments may be described and claimed.

### TECHNICAL FIELD

The present disclosure relates generally to wireless communication systems, and more particularly, to methods and apparatus for distributing link-state information associated with a wireless mesh network.

### BACKGROUND

Link-state routing protocols such as Open Shortest Path First (OSPF) protocol and Optimized Link State Routing (OLSR) protocol may be used to identify routes in wired and/or wireless networks (e.g., multi-hop wireless mesh networks). In one example, nodes in a network may identify the best path between a source and a destination in the network. Typically in accordance with a link-state routing protocol, each node in the network may periodically report a full set of link-state metrics to all nodes in the network. For example, a link-state metric may include information indicative of link characteristics such as quality of a link between two nodes in the network. Each node may also generate a link-state table of the network topology based on the reports from other nodes in the network (e.g., hello messages). Accordingly, the node may execute a path algorithm (e.g., Dijkstra's algorithm) on the link-state table to identify the optimal route from a source to one or more destinations in the network.

### BRIEF DESCRIPTION OF THE DRAWINGS

FIG. 1 depicts an example wireless mesh network according to an embodiment of the methods and apparatus described herein.

FIG. 2 is a block diagram representation of an example primary relay node of FIG. 1.

FIG. 3 depicts example primary relay nodes associated with an example wireless mesh network of FIG. 1.

FIG. 4 depicts an example neighbor table that may be used to implement an example primary relay node of FIG. 3.

FIG. 5 depicts an example raw link-state list that may be used to implement an example primary relay node of FIG. 3.

FIG. 6 depicts an example adjacency bit array that may be used to implement an example primary relay node of FIG. 3.

FIG. 7 depicts an example link-state message that may be used to implement an example primary relay node of FIG. 3.

FIG. 8 is a flow diagram representation of one manner in which an example primary relay node of FIG. 2 may be configured to distribute link-state information associated with a wireless mesh network.

FIG. 9 is a block diagram representation of an example processor system that may be used to implement an example primary relay node of FIG. 2.

### DETAILED DESCRIPTION

In general, methods and apparatus for distributing link-state information associated with a wireless mesh network having a plurality of mesh nodes are described herein. According to one example embodiment, a primary relay node of the wireless mesh network may identify one or more links of a neighborhood associated with the primary relay node. The primary relay node may be selected by one or more neighboring nodes relative to the primary relay node. The primary relay node may generate a link-state message having link-state information associated with each of the one or more links identified by the primary relay node. As a result, the primary relay node may reduce the overhead required to distribute the link-state information across the wireless mesh network to the plurality of mesh nodes. The methods and apparatus described herein are not limited in this regard.

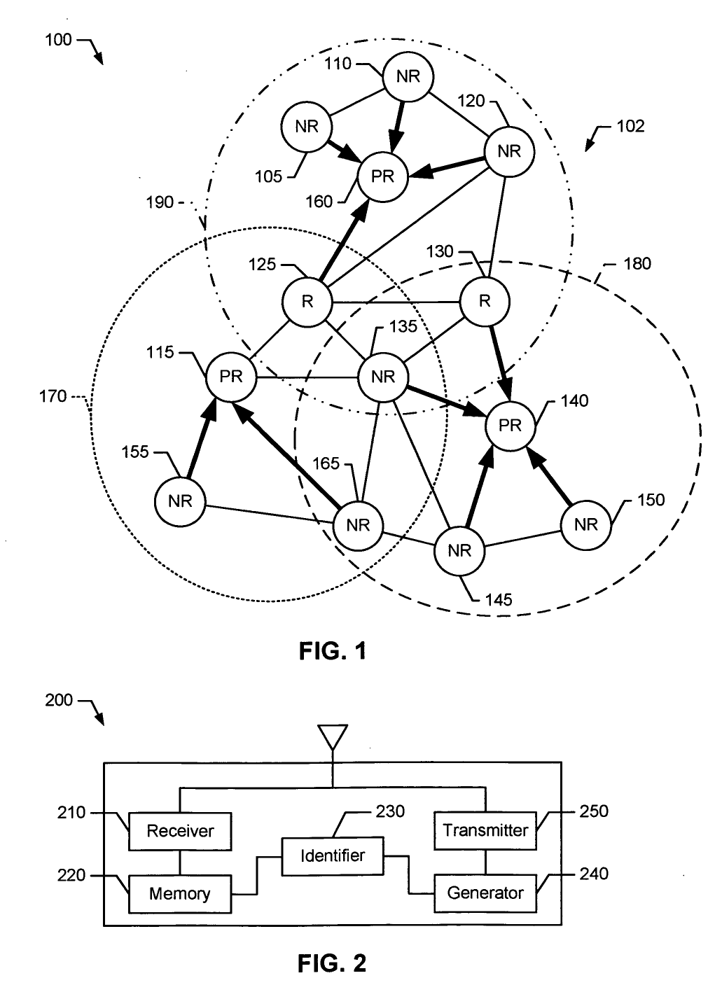

Referring to FIG. 1, an example wireless mesh network 100 including a plurality of mesh nodes 102 is described herein. Although FIG. 1 depicts thirteen mesh nodes, the wireless mesh network 100 may include additional or fewer mesh nodes. As described in detail below, the plurality of nodes 102 may include access points, redistribution points, end points, and/or other suitable connection points for traffic flows via mesh routes having multiple hops.

The plurality of nodes 102 may operate in accordance with one or more of several wireless communication protocols to communicate with each other and/or other wireless devices (e.g., a laptop computer, a handheld computer, a tablet computer, a cellular telephone a wireless peripheral, etc.). In particular, these wireless communication protocols may be based on analog, digital, and/or dual-mode communication system standards such as the Global System for Mobile Communications (GSM) standard, the Frequency Division Multiple Access (FDMA) standard, the Time Division Multiple Access (TDMA) standard, the Code Division Multiple Access (CDMA) standard, the Wideband CDMA (WCDMA) standard, the General Packet Radio Services (GPRS) standard, the Enhanced Data GSM Environment (EDGE) standard, the Universal Mobile Telecommunications System (UMTS) standard, variations and evolutions of these standards, and/or other suitable wireless communication standards.

The plurality of nodes 102 may also communicate with other components associated with the wireless mesh network 100 such as wireless local area network (WLAN) devices and/or wireless wide area network (WWAN) devices (not shown) including network interface devices and peripherals (e.g., network interface cards (NICs)), access points (APs), gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system.

The plurality of nodes 102 may use a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation, multi-carrier modulation (MDM), and/or other suitable modulation techniques to communicate with each other. In particular, the plurality of nodes 102 may use OFDM modulation as described in the 802.xx family of standards developed by the Institute of Electrical and Electronic Engineers (IEEE) and/or variations and evolutions of these standards (e.g., 802.11 x, 802.15, 802.16x, etc.) to communicate via the wireless communication links with each other. The plurality of nodes 102 may also operate in accordance with other suitable wireless communication protocols that require very low power such as Bluetooth, Ultra Wideband (UWB), and/or radio frequency identification (RFID) to communicate with each other. The methods and apparatus described herein are not limited in this regard.

To reduce the overhead required to distribute link-state information across the wireless mesh network 100, primary relay nodes may be selected to generate and forward the link-state information as described herein. The primary relay nodes may be a subset of relay nodes of the wireless mesh network 100. The link-state information may include metric associated with each link of the wireless mesh network 100. For example, the link-state information may include information indicative of quality (e.g., signal-to-noise ratio), available bandwidth (e.g., data rate), and/or other characteristics associated with each link. As a result, the plurality of mesh nodes 102 may identify the best route between a source and a destination in the wireless mesh network 100 based on the link-state information from the primary relay nodes.

In particular, the plurality of nodes 102 may include one or more non-relay nodes (NR), generally shown as 105, 110, 120, 135, 145, 150, 155, and 165. The plurality of mesh nodes 102 may also include one or more relay nodes (R), generally shown as 125 and 130. Further, the plurality of mesh nodes 102 may include one or more primary relay nodes (PR), generally shown as 115, 140, and 160.

The primary relay nodes of the wireless mesh network 100 may be selected from the relay nodes by primary relay selector (PRS) nodes based on a backbone selection protocol such as a reorganization (ReOrg) protocol, a multipoint relay (MPR) protocol, a link cluster algorithm (LCA) protocol, and/or other suitable selection protocols. For example, the primary relay nodes 115, 140, and 160 may be selected as described in Conner et al., U.S. patent application Ser. No. 10/132,947 (U.S. Publication No. 2003/0202524). The PRS nodes of a primary relay node may include relay nodes and/or non-relay nodes in a neighborhood associated with the primary relay node.

As indicated by black arrows, for example, the non-relay nodes 155 and 165 may select the mesh node 115 to operate as the primary relay node associated with a neighborhood 170 including the mesh nodes 115, 125, 135, 155, and 165. In another example, the non-relay nodes 135, 145, and 150 and the relay node 130 may select the mesh node 140 to operate as the primary relay node associated with a neighborhood 180 including the nodes 130, 135, 140, 145, and 150. In yet another example, the non-relay nodes 105, 110, and 120 and the relay node 125 may select the mesh node 160 as the primary relay node associated with a neighborhood 190 including the nodes 105, 110, 120, 125, and 160. The methods and apparatus described herein are not limited in this regard.

Turning to FIG. 2, for example, a primary relay node 200 (e.g., the primary relay nodes 115, 140, and 160 of FIG. 1) may include a receiver 210, a memory 220, an identifier 230, a generator 240, and a transmitter 250. The receiver 210 may receive a hello message from one or more neighboring nodes of the primary relay node 200 and store the hello message in a neighbor table (e.g., one shown as 400 in FIG. 4) in the memory 220. In one example, the primary relay node 115 may receive hello messages from the nodes 125, 135, 155, and/or 165. The primary relay node 140 may receive hello messages from the nodes 130, 135, 140, 150, and/or 165. The primary relay node 160 may receive hello messages from the nodes 105, 110, 120, 125, 130, and/or 135. As shown in FIG. 1, some mesh nodes may be a neighboring node in one or more neighborhoods. For example, the node 135 may be a neighboring node to the primary relay node 115 in the neighborhood 170, a neighboring node to the primary relay node 140 in the neighborhood 180, and a neighboring node to the primary relay node 160 in the neighborhood 190.

A hello message from a neighboring node may include node address information associated with the neighboring node such as a Media Access Control (MAC) address, an Internet Protocol (IP) address, etc. As described in detail below, a neighboring node of the primary relay node 200 may be either a PRS node or a non-PRS node relative to the primary relay node 200. As noted above, a PRS node may be a mesh node (e.g., a relay node or a non-relay node) that selects a relay node to operate as its primary relay node. Accordingly, the hello message may include information indicative of whether the neighboring node is a PRS node associated with the primary relay node 200. The hello message may also include metric of a link between the primary relay node 200 and the neighboring node (e.g., available bandwidth, energy, and/or other link characteristics). Further, the hello message may include a neighbor list of the neighboring node. That is, the neighbor list may include node address information and metric information associated with one or more neighboring nodes relative to the mesh node transmitting the hello message.

The identifier 230 may identify one or more links of a neighborhood associated with the primary relay node 200 to report corresponding link-state information to all mesh nodes of a wireless mesh network. For example, the primary relay node 200 may identify a link associated with the primary relay node 200 and a PRS node relative to the primary relay node 200 (e.g., a mesh node that selected the primary relay node 200). The primary relay node 200 may also identify a link associated with the primary relay node 200 and a non-PRS node having a node address larger than a node address of the primary relay node 200 (e.g., a mesh node that selected another relay node as the primary relay node corresponding to that particular mesh node). In another example, the primary relay node 200 may identify a link associated with two PRS nodes relative to the primary relay node 200. Further, the primary relay node 200 may identify a link associated with a PRS node and a non-PRS node having a node address greater than a node address of the PRS node.

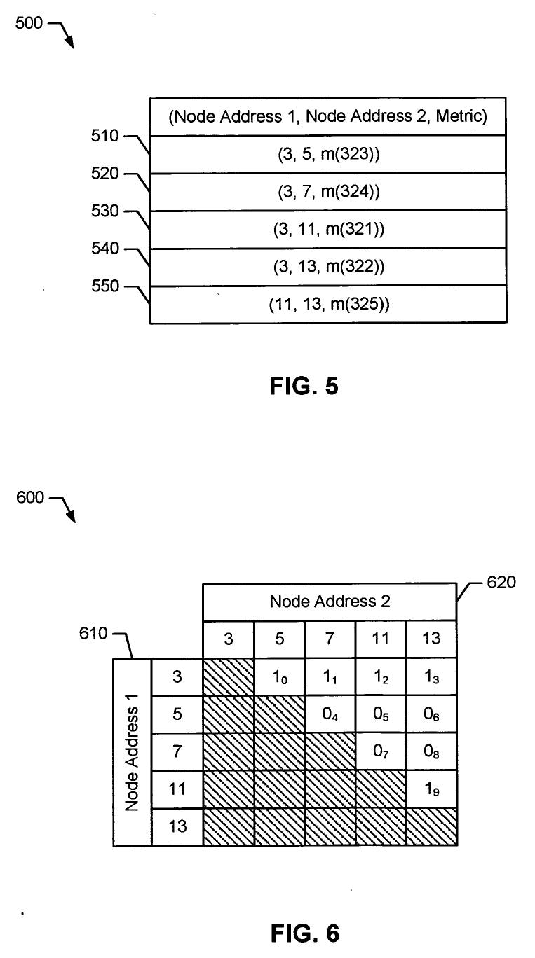

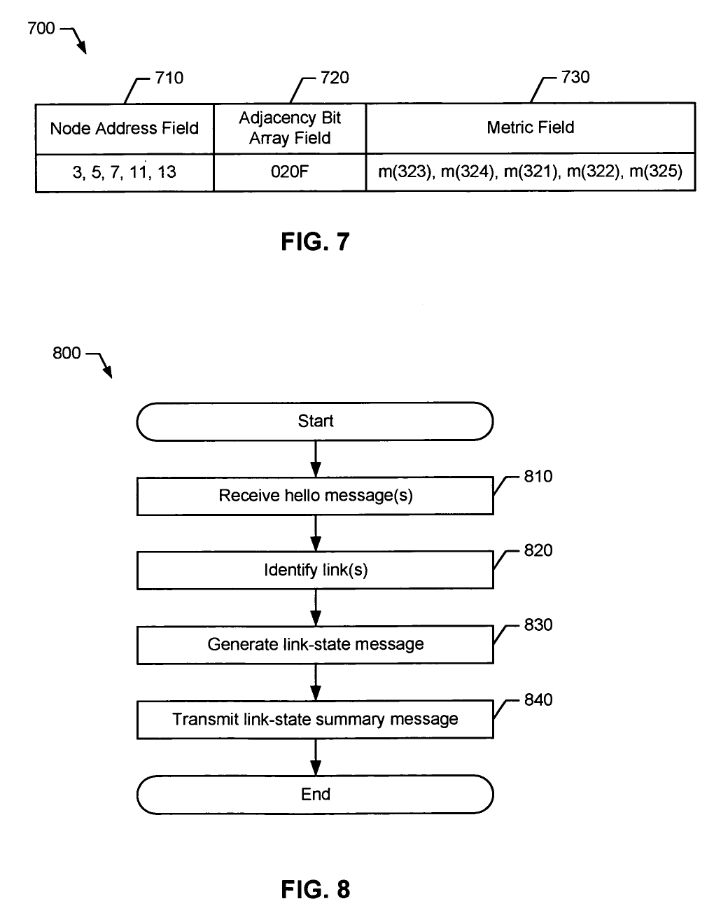

Based on the neighbor list stored in the memory 220, the generator 240 may generate a link-state message having link-state information associated with each of the links identified by the identifier 230 as noted above. In particular, the generator 240 may generate a raw link-state list (e.g., the raw link-state list 500 of FIG. 5) and an adjacency bit array (e.g., the adjacency bit array 600 of FIG. 6). To distribute the link-state information efficiently, the generator 240 may encode the link-state information in a message format (e.g., the link-state message 700 of FIG. 7) based on the raw link-state list and the adjacency bit array. Accordingly, the transmitter 250 may transmit the link-state message to the plurality of mesh nodes 102 of the wireless mesh network 100.

While the components shown in FIG. 2 are depicted as separate blocks within the primary relay node 200, the functions performed by some of these blocks may be integrated within a single semiconductor circuit or may be implemented using two or more separate integrated circuits. For example, although the receiver 210 and the transmitter 250 are depicted as separate blocks within the primary relay node 200, the receiver 210 may be integrated into the transmitter 250 (e.g., a transceiver). The methods and apparatus described herein are not limited in this regard.

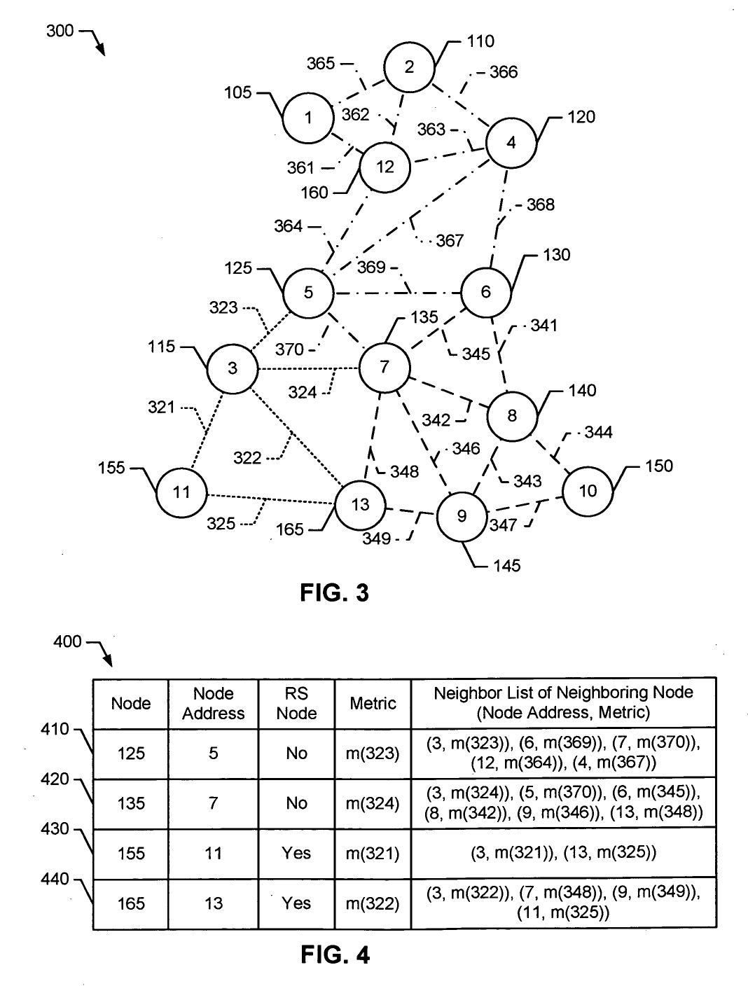

To distribute link-state information associated with the wireless mesh network 100, a primary relay node (e.g., the primary relay nodes 115, 140, and 160) may identify one or more links of a neighborhood associated with the primary relay node. Referring to FIGS. 1 and 3, for example, the primary relay nodes 115, 140, and 160 may correspond to node addresses 3, 8, and 12, respectively. Accordingly, the neighboring nodes 105, 110, 120, 125, 130, 135, 145, 150, 155, and 165 may correspond to node addresses 1, 2, 4, 5, 6, 7, 9, 10, 11, and 13, respectively. As described in detail below, each of the neighboring nodes 105, 110, 120, 125, 130, 135, 145, 150, 155, and 165 may be either a PRS node or a non-PRS node relative to each of the primary relay nodes 115, 140, and 165.

In one example, the primary relay node 115 may identify links associated with the neighboring nodes 125, 135, 155, and 165 (e.g., the mesh nodes associated with the neighborhood 170). The neighboring nodes 155 and 165 may be PRS nodes and the neighboring nodes 125 and 135 may be non-PRS nodes relative to the primary relay node 115. In particular, the primary relay node 115 may identify a link 321 between the primary relay node 115 (e.g., node address 3) and the PRS node 155 (e.g., node address 11), and a link 322 between the primary relay node 115 and the PRS node 165 (e.g., node address 13) because the neighboring nodes 155 and 165 are PRS nodes relative to the primary relay node 115 (e.g., the mesh nodes 155 and 165 selected the mesh node 115 to operate as their primary relay node). Further, the primary relay node 115 may identify a link 325 between the PRS nodes 155 and 165 because the link 325 is a link associated with two PRS nodes that selected the mesh node 115 to operate as their corresponding primary relay node.

As noted above, the neighboring nodes 125 and 135 may be non-PRS nodes relative to the primary relay node 115 (e.g., mesh nodes that did not select the mesh node 115 to operate their primary relay node). The primary relay node 115 may also identify a link 323 between the primary relay node 115 and the non-PRS node 125 (e.g., node address 5), and a link 324 between the primary relay node 115 and the non-PRS node 135 (e.g., node address 7) because the node address of each of the non-PRS nodes 125 and 135 is greater than the node address of the primary relay node 115. In particular, the node address of the primary relay node 115 is 3, and the node addresses of the non-PRS nodes 125 and 135 are 5 and 7, respectively. Thus, each of the node addresses of the non-PRS nodes 125 and 135 is greater than the node address of the primary relay node 115. Otherwise if the node address of a non-PRS node is less than the node address of the primary relay node 115, the primary relay node 115 may not report the link-state information associated with the particular non-PRS node. As noted above, the node address may be a MAC address, an IP address, and/or other suitable address to identify a mesh node. For example, if the node addresses are MAC addresses or IP addresses, the MAC addresses or IP addresses may be converted to numerical values for comparison of the node addresses.

In another example, the primary relay node 140 may identify links associated with the neighboring nodes 130, 135, 145, 150, and 165 (e.g., the mesh nodes associated with the neighborhood 180). The neighboring nodes 130, 135, 145, and 150 may be PRS nodes and the neighboring node 165 may be a non-PRS node relative to the primary relay node 140. In contrast to the above example, the neighboring node 135 (e.g., node address 7) may be a PRS node relative to the primary relay node 140 and a non-PRS node relative to the primary relay node 115. In a similar manner, the neighboring node 165 (e.g., node address 13) may be a PRS node relative to the primary relay node 115 and a non-PRS node relative to the primary relay node 140.

The primary relay node 140 may identify a link 341 between the primary relay node 140 and the PRS node 130 (e.g., node address 6), a link 342 between the primary relay node 140 and the PRS node 135 (e.g., node address 7), a link 343 between the primary relay node 140 and the PRS node 145 (e.g., node address 9), and a link 344 between the primary relay node 140 and the PRS node 150 (e.g., node address 10) because the mesh nodes 130, 135, 145, and 150 are PRS nodes relative to the primary relay node 115 (e.g., the mesh nodes 130, 135, 145, and 150 selected the mesh node 115 to operate as their primary relay node). The primary relay node 140 may also identify a link 345 between the PRS nodes 130 and 135, a link 346 between the PRS nodes 135 and 145, and a link 347 between the PRS nodes 145 and 150 because each of the links 345, 346, and 347 is a link associated with two PRS nodes that selected the mesh node 140 to operate as their corresponding primary relay node.

Further, the primary relay node 140 may identify a link 348 between the neighboring nodes 135 and 165 and a link 349 between the neighboring nodes 145 and 165 because each of the links 348 and 349 is a link associated with a PRS node and a non-PRS node having an address greater than a node address of the PRS node. That is, the address of the non-PRS node 165 is 13, and the node addresses of the PRS nodes 135 and 145 are 7 and 9, respectively. Thus, the node address of the non-PRS node 165 is greater than each of the node addresses of the PRS nodes 135 and 145.

In yet another example, the primary relay node 160 may identify links associated with the neighboring nodes 105, 110, 120, 125, 130, and 135 (e.g., the mesh nodes associated with the neighborhood 190). The neighboring nodes 105, 110, 120, and 125 may be PRS nodes and the neighboring nodes 130 and 135 may be non-PRS nodes relative to the primary relay node 160. In contrast to the above examples, the neighboring node 125 (e.g., node address 5) may be a PRS node relative to the primary relay node 160 and a non-PRS node relative to the primary relay node 115. In a similar manner, the neighboring node 130 (e.g., node address 6) may be a PRS node relative to the primary relay node 140 and a non-PRS node relative to the primary relay node 160. Further, the neighboring node 135 (e.g., node address 7) may be a PRS node to the primary relay node 140 and a non-PRS node relative to the primary relay nodes 115 and 160.

The primary relay node 160 may identify a link 361 between the primary relay node 160 and the neighboring node 105 (e.g., node address 1), a link 362 between the primary relay node 160 and the neighboring node 110 (e.g., node address 2), a link 363 between the primary relay node 160 and the neighboring node 120 (e.g., node address 4), and a link 364 between the primary relay node 160 and the neighboring node 125 (e.g., node address 5) because the neighboring nodes 105, 110, 120, and 125 selected the mesh node 160 to operate as their corresponding primary relay node. The primary relay node 160 may also identify a link 365 between the PRS nodes 105 and 110, a link 366 between the PRS nodes 110 and 120, and a link 367 between the PRS nodes 120 and 125 because each of the links 365, 366, and 367 is a link associated with two PRS nodes that selected the mesh node .160 to operate as their corresponding primary relay node.

In addition, the primary relay node 160 may identify a link 368 between the PRS node 120 and the non-PRS node 130, a link 369 between the PRS node 125 and the non-PRS node 130, and a link 370 between the PRS node 125 and the non-PRS node 135 because each of the links 368, 369, and 370 is a link associated with a PRS node and a non-PRS node having a node address greater than a node address of the PRS node. That is, the node addresses of the non-PRS nodes 130 and 135 are 6 and 7, respectively, and the node addresses of the relay selector nodes 120 and 125 are 4 and 5, respectively. Thus, each of the node addresses of the non-PRS nodes 130 and 135 is greater than each of the node addresses of the PRS nodes 120 and 125.

As a result, each link of the wireless mesh network 100 may be identified and link-state information associated with each link may reported by one primary relay node. Thus, the primary relay nodes 115, 140, and 160 may reduce the overhead required to distribute the link-state information across the wireless mesh network 100 to the plurality of mesh nodes 102 as described herein.

In FIG. 4, for example, a neighbor table 400 of the primary relay node 115 may include neighboring node address information 410, PRS node information 420, metric information 430, and neighbor list information 440. Each hello message received by the primary relay node 115 (e.g., via the receiver 210) may correspond to a row in the neighbor table 400. For example, the hello message from the neighboring node 125 may correspond to the row 410, and the hello message from the neighboring node 165 may correspond to the row 440.

The primary relay nodes 115, 140, and 160 may avoid reporting duplicate link-state information by identifying links as described above. The primary relay nodes 115, 140, and 160 may also reduce the overhead to distribute the link-state information associated with the wireless mesh network 100. For example, the primary relay node 115 may generate a raw link-state list (e.g., one shown as 500 in FIG. 5) based on the neighbor table 400. Turning to FIG. 5, the example raw link-state list 500 may include one or more entries, generally shown as 510, 520, 530, 540, and 550. Each entry may correspond to a link identified by the identifier 220 to report to the plurality of mesh nodes 102. In particular, each entry may include nodes addresses of the nodes associated with the identified link and metric of the identified link. In one example, the entry 510 may correspond to the link 323 between the nodes 115 and 125. Accordingly, the entry 510 may include the node addresses of the nodes 115 and 125 and the metric of the link 323. In another example, the entry 550 may correspond to the link 325 between the nodes 155 and 165. The entry 550 may include the node addresses of the nodes 155 and 165 and the metric of the link 325. The methods and apparatus described herein are not limited in this regard.

Based on the raw link-state list 500, the primary relay node 115 may generate an adjacent bit array (e.g., one shown as 600 in FIG. 6) having an n x n-bit matrix, where n is a number of node addresses in the raw link-state list 500 of identified links to report to the plurality of mesh nodes 102 by the primary relay node 115. Referring to FIG. 6, for example, the adjacent bit array 600 may be a 5 x 5 matrix of twenty-five boxes. In particular, the adjacent bit array 600 may include a column 610 to identify the Node Address 1 field and a row 620 to identify the Node Address 2 field of the raw link-state list 500. Each of the column 610 and the row 620 may include the node addresses of the nodes 115, 125, 135, 155, and 165 (e.g., 3, 5, 7, 11, and 13, respectively).

Each link of the neighborhood 170 may correspond to a one-bit box in the adjacent bit array 600. For example, a numeral one (“1”) may be used to indicate a link between two nodes. In one example, the link 323 between the nodes 115 and 125 (e.g., addresses 3 and 5, respectively) may be indicated in the box (3, 5) with a numeral one (“1”). In another example, the link 325 between the nodes 155 and 165 (e.g., node addresses 11 and 13, respectively) may be indicated in the box (11, 13) with a numeral one (“1”). Otherwise, a numeral zero (“0”) may be used to indicate a lack of a link between two node addresses. For example, the box (5, 7) may include a zero to indicate that a link fails to exist between the nodes 125 and 135 (e.g., node addresses 5 and 7, respectively). Likewise, the box (7, 13) may include a zero to indicate that a link fails to exist between the nodes 135 and 165 (e.g., node addresses 7 and 13, respectively).

To avoid reporting duplicate link-state information, some links may not be indicated in the adjacency bit array 600 (e.g., shown as shaded boxes). For example, a link between the nodes 125 and 115 (e.g., addresses 5 and 3, respectively) may be the same as the link 323 between the nodes 115 and 125. Thus, the box (5, 3) may be shaded because the box (3, 5) may represent the link 323. In a similar manner, the box (13, 7) may be shaded because the box (7, 13) may represent the same combination of node addresses. The methods and apparatus described herein are not limited in this regard.

Based on the adjacency bit array 600, the primary relay node 115 may generate a link-state message (e.g., one shown as 700 in FIG. 7) having link-state information to distribute to the plurality of mesh nodes 102. In the example of FIG. 7, a link-state message 700 may include a node address field 710, an adjacency bit array field 720, and a metric field 730. The node address field 710 may include a node address associated with each neighboring node of the neighborhood 170. For example, the node address field 710 may include the node addresses 3, 5, 7, 11, and 13 of the neighboring nodes 115, 125, 135, 155, and 165, respectively.

The adjacency bit array field 720 may correspond to the adjacency bit array 600. For example, the adjacency bit array 600 may be represented by a hexadecimal value based on the one-bit boxes in the matrix. That is, the adjacency bit array 600 may be represented by a binary value of 1000001111 with the least significant bit represented by the box (3, 5) (e.g., “1_{O}”) and the most significant bit represented by the box (11, 13) (e.g., “1₉”). Accordingly, the binary value 1000001111 may be represented by a hexadecimal value of 020F.

The metric field 730 may include a metric associated with each link of the neighborhood associated with the primary relay node 115. For example, the metric field 730 may include the metrics m(323), m(324), m(321), m(322), and m(325) as indicated by the raw link-state list 500 (FIG. 5). As noted above, the metric of a link may be indicative of quality (e.g., signal-to-noise ratio), available bandwidth (e.g., data rate), and/or other characteristics associated with the link.

Although the examples in connections with FIGS. 4, 5, and 6 are described above in conjunction with the primary relay node 115 of FIGS. 1 and 3, the methods and apparatus described herein may be implemented by the primary relay nodes 140 and 160 to distribute link-state information associated with the wireless mesh network 100. The methods and apparatus described herein are not limited in this regard.

In particular, FIG. 8 depicts one manner in which each of the example primary relay nodes 115, 140, and 160 of FIG. 3 may be configured to distribute link-state information associated with the wireless mesh network 100. The example process 800 of FIG. 8 may be implemented as machine-accessible instructions utilizing any of many different programming codes stored on any combination of machine-accessible media such as a volatile or nonvolatile memory or other mass storage device (e.g., a floppy disk, a CD, and a DVD). For example, the machine-accessible instructions may be embodied in a machine-accessible medium such as a programmable gate array, an application specific integrated circuit (ASIC), an erasable programmable read only memory (EPROM), a read only memory (ROM), a random access memory (RAM), a magnetic media, an optical media, and/or any other suitable type of medium.

Further, although a particular order of actions is illustrated in FIG. 8, these actions can be performed in other temporal sequences. Again, the example process 800 is merely provided and described in conjunction with the apparatus of FIG. 2 as an example of one way to configure a mesh node to operate as one of the example primary relay nodes in the wireless mesh network 100.

In the example of FIG. 8, the process 800 begins with the primary relay node 200 (e.g., via the receiver 210) receiving hello messages from neighboring nodes (block 810). For example, the primary relay node 115 (FIG. 1) may receive hello messages from the neighboring nodes 125, 135, 155, and 165 of the neighborhood 170. The primary relay node 200 may store the hello messages in a neighbor table (e.g., the neighbor table 400 of FIG. 4) in the memory 220.

Based on the neighbor table, the primary relay node 200 (e.g., via the identifier 230) may identify one or more links of a neighborhood associated with the primary relay node 200 (block 820). For example, the primary relay node 200 may identify: (1) a link associated with the primary relay node and a relay selector node that selected the mesh node 200 to operate as a primary relay node where the mesh node 200 may not be the primary relay selector of a neighboring node or the mesh node 200 may have an address smaller than an address of the neighboring node, (2) a link associated with the primary relay node and a non-relay selector node having an address greater than an address of the primary relay node where the mesh node 200 may not be the primary relay selector of a neighboring node, (3) a link associated with two relay selector nodes that selected the mesh node 200 to operate as a primary relay node, and (4) a link associated with a relay selector node that selected the mesh node 200 to operate as a primary relay node and a non-relay selector node having a node address greater than a node address of the relay selector node where the relay selector node is not a primary relay node.

Accordingly, the primary relay node 200 (e.g., via the generator 240) may generate a link-state message having link-state information associated with each of the identified links (block 830). For example, the primary relay node 200 may generate a raw link-state list (e.g., the raw link-state list 500 of FIG. 5) having an entry corresponding to each of the identified links. The primary relay node 200 may also generate an adjacency bit array (e.g., the adjacency bit array 600 of FIG. 6). Based on the raw link-state list and the adjacency bit array, the primary relay node 200 may generate a link-state message having link-state information associated with each of the identified links (e.g., the link-state message 700 of FIG. 7). The primary relay node 200 may reduce resources required to distribute the link-state information by formatting the link-state information in a configuration as shown in FIG. 7.

The primary relay node 200 may transmit the link-state message to the plurality of mesh nodes 102 in the wireless mesh network 100 (block 840). As a result, the primary relay nodes such as 115, 140, and 160 of the wireless mesh network 100 may avoid distributing duplicate link-state information. The methods and apparatus described herein are not limited in this regard;

Although the methods and apparatus disclosed herein are well suited for wireless mesh networks, the methods and apparatus disclosed herein are readily applicable to many other types of communication networks. For example, the methods and apparatus disclosed herein may be used to implement wireless personal area networks (WPANs), wireless local area networks (WLANs), wireless metropolitan area networks (WMANs), and/or wireless wide area networks (WWANs).

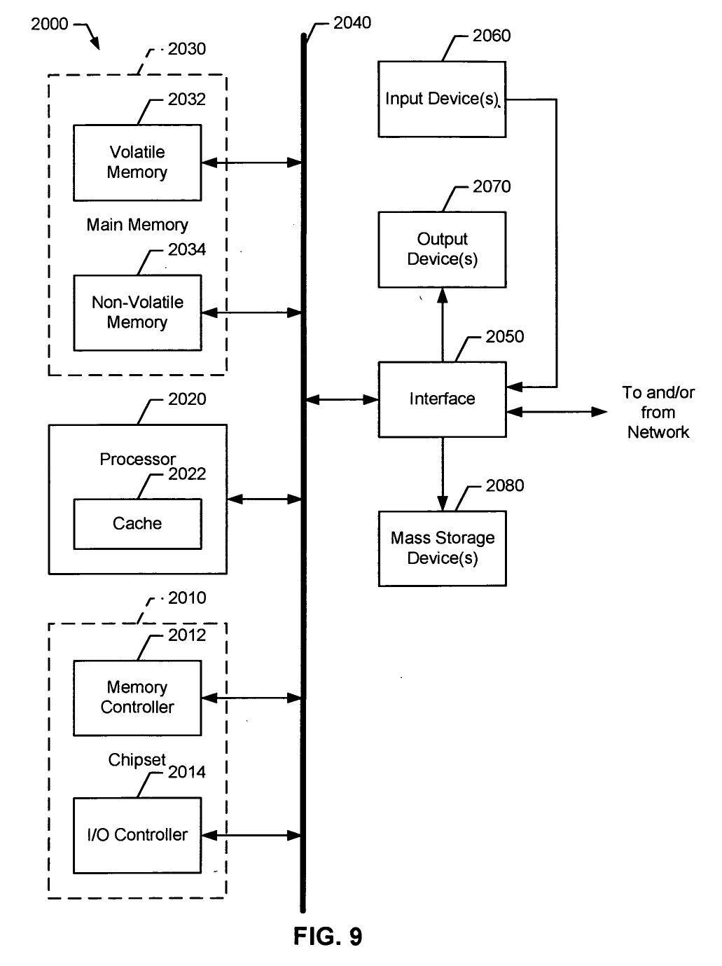

FIG. 9 is a block diagram of an example processor system 2000 adapted to implement the methods and apparatus disclosed herein. The processor system 2000 may be a desktop computer, a laptop computer, a handheld computer, a tablet computer, a PDA, a server, an Internet appliance, and/or any other type of computing device.

The processor system 2000 illustrated in FIG. 9 includes a chipset 2010, which includes a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, WLAN components, WMAN components, WWAN components, and/or other suitable processing components. For example, the processor 2020 may be implemented using one or more of the Intel® Pentium® technology, the Intel® Itanium® technology, the Intel® Centrino™ technology, the Intel® Xeon ™ technology, and/or the Intel® XScale® technology. In the alternative, other processing technology may be used to implement the processor 2020. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2034 may be implemented using flash memory, Read Only Memory (ROM), Electrically Erasable Programmable Read Only Memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output interface (3GIO) interface, and/or any other suitable type of interface.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the I/O controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 9 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain example methods, apparatus, and articles of manufacture have been described herein, the scope of coverage of this disclosure is not limited thereto. On the contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
identifying one or more links of a neighborhood associated with a primary relay node of a wireless mesh network having a plurality of mesh nodes; and
generating a link-state message having link-state information associated with each of the one or more links.

2. A method as defined in claim 1, wherein identifying the one or more links of the neighborhood associated with the primary relay node comprising identifying a link associated with the primary relay node and a primary relay selector node.

3. A method as defined in claim 1, wherein identifying the one or more links of the neighborhood associated with the primary relay node comprising identifying a link associated with the primary relay node and a non-primary relay selector node having a node address greater than a node address of the primary relay node.

4. A method as defined in claim 1, wherein identifying the one or more links of the neighborhood associated with the primary relay node comprising identifying a link associated with a first primary relay selector node and a second primary relay selector node, and wherein the first and second primary relay selector nodes selected the primary relay node.

5. A method as defined in claim 1, wherein identifying the one or more links of the neighborhood associated with the primary relay node comprising identifying a link associated with a primary relay selector node that selected the primary relay node and a non-primary relay selector node having a node address greater than a node address of the primary relay selector node.

6. A method as defined in claim 1, wherein generating the link-state message having link-state information associated with each of the one or more links comprises generating the link-state message based on one or more of a hello message from a mesh node associated with the neighborhood, a raw link-state list, or an adjacent bit array.

7. A method as defined in claim 1 further comprising selecting the primary relay node from the plurality of relay nodes based on a backbone selection protocol.

8. A method as defined in claim 1 further comprising transmitting the link-state information to one or more of the plurality of mesh nodes.

9. An article of manufacture including content, which when accessed, causes a machine to:
identify one or more links of a neighborhood associated with a primary relay node of a wireless mesh network having a plurality of mesh nodes; and
generate a link-state message having link-state information associated with each of the one or more links.

10. An article of manufacture as defined in claim 9, wherein the content, when accessed, causes the machine to identify the one or more links of the neighborhood associated with the primary relay node by identifying a link associated with the primary relay node and a primary relay selector node.

11. An article of manufacture as defined in claim 9, wherein the content, when accessed, causes the machine to identify the one or more links of the neighborhood associated with the primary relay node by identifying a link associated with the primary relay node and a non-primary relay selector node having a node address greater than a node address of the primary relay node.

12. An article of manufacture as defined in claim 9, wherein the content, when accessed, causes the machine to identify the one or more links of the neighborhood associated with the primary relay node by identifying a link associated with a first primary relay selector node and a second primary relay selector node, and wherein the first and second primary relay selector nodes selected the primary relay node.

13. An article of manufacture as defined in claim 9, wherein the content, when accessed, causes the machine to identify the one or more links of the neighborhood associated with the primary relay node by identifying a link associated with a primary relay selector node that selected the primary relay node and a non-primary relay selector node having a node address greater than a node address of the primary relay selector node.

14. An article of manufacture as defined in claim 9, wherein the content, when accessed, causes the machine to generate the link-state message having link-state information associated with each of the one or more links by generating the link-state message based on one or more of a hello message from a mesh node associated with the neighborhood, a raw link-state list, or an adjacent bit array.

15. An article of manufacture as defined in claim 9, wherein the content, when accessed, causes the machine to transmit the link-state information to one or more of the plurality of mesh nodes.

16. An apparatus comprising:
an identifier to identify one or more links of a neighborhood associated with a primary relay node of a wireless mesh network having a plurality of mesh nodes; and
a generator to generate a link-state message having link-state information associated with each of the one or more links.

17. An apparatus as defined in claim 16, wherein the identifier is configured to identify a link associated with the primary relay node and a primary relay selector node.

18. An apparatus as defined in claim 16, wherein the identifier is configured to identify a link associated with the primary relay node and a non-primary relay selector node having a node address greater than a node address of the primary relay node.

19. An apparatus as defined in claim 16, wherein the identifier is configured to identify a link associated with a first primary relay selector node and a second primary relay selector node, and wherein the first and second primary relay selector nodes selected the primary relay node.

20. An apparatus as defined in claim 16, wherein the identifier is configured to identify a link associated with a primary relay selector node that selected the primary relay node and a non-primary relay selector node having a node address greater than a node address of the primary relay selector node.

21. An apparatus as defined in claim 16, wherein the generator is configured to generate the link-state message based on one or more of a hello message from a mesh node associated with the neighborhood, a raw link-state list, or an adjacent bit array.

22. An apparatus as defined in claim 16 further comprising a transmitter to transmit the link-state message to one or more of the plurality of mesh nodes.

23. A system comprising:
a transceiver; and
a processor coupled to the transceiver to identify one or more links of a neighborhood associated with a primary relay node of a wireless mesh network having a plurality of mesh nodes, and to generate a link-state message having link-state information associated with each of the one or more links.

24. A system as defined in claim 23, wherein the processor is configured to identify a link associated with the primary relay node and a primary relay selector node.

25. A system as defined in claim 23, wherein the processor is configured to identify a link associated with the primary relay node and a non-primary relay selector node having a node address greater than a node address of the primary relay node.

26. A system as defined in claim 23, wherein the processor is configured to identify a link associated with a first primary relay selector node and a second primary relay selector node, and wherein the first and second primary relay selector nodes selected the primary relay node.

27. A system as defined in claim 23, wherein the processor is configured to identify a link associated with a primary relay selector node that selected the primary relay node and a non-primary relay selector node having a node address greater than a node address of the primary relay selector node.

28. A system as defined in claim 23, wherein the processor is configured to generate the link-state message based on one or more of a hello message from a mesh node associated with the neighborhood, a raw link-state list, or an adjacent bit array.

29. A system as defined in claim 23, wherein the processor is configured to transmit the link-state message to one or more of the plurality of mesh nodes.
